(19) United States
(12) Patent Application Publication
(10) Pub. No.: US 2010/0103109 A1
(43) Pub. Date: Apr. 29, 2010

(54) Handheld Device having Movable Keyboard

(75) Inventors: Yi-Feng Sun, Shanghai City (CN); Shih-Kuang Tsai, Shanghai City (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INVENTEC APPLIANCES CORP., Taipei Hsien (TW)

(21) Appl. No.: 12/369,184

(22) Filed: Feb. 11, 2009

(30) Foreign Application Priority Data
Oct. 24, 2008 (TW) 97219086

(51) Int. Cl. G06F 3/02

(52) U.S. Cl. 345/168

(57) ABSTRACT

A handheld device having a movable keyboard is described. The handheld device comprises: a body, wherein a surface of the body includes a first region and a second region; a display module disposed in the body, and comprising a display screen exposed in the first region of the body; a handwriting input module disposed in the body, and comprising a handwriting screen located in the second region of the surface of the body; and a movable keyboard module slidably disposed over the surface of the body.

### RELATED APPLICATIONS

This application claims priority to Taiwan Application Serial Number 97219086, filed Oct. 24, 2008, which is herein incorporated by reference.

### FIELD OF THE INVENTION

The present invention relates to a handheld device, and more particularly to a handheld device having a movable keyboard.

### BACKGROUND OF THE INVENTION

As handheld devices become increasingly smaller, the front space of the handheld device decreases. Most of the front of each handheld device is used as a display region, so that in order to reserve more space for the display region, most of the handheld devices are not equipped with QWERTY standard keyboards. Although some handheld devices are equipped with QWERTY standard keyboards, the QWERTY standard keyboards cannot be disposed in the front spaces of the handheld devices due to the limitation of the sizes of the handheld devices.

However, as handheld devices become more popular, more consumers perform input operations through keyboards when using the handheld devices, so there is a need for handheld devices equipped with keyboards, especially QWERTY standard keyboards.

According with the aforementioned description, a handheld device that can give consideration to the equipment of a keyboard input device and the keeping of the front display space is need.

### SUMMARY OF THE INVENTION

Therefore, one aspect of the present invention is to provide a handheld device having a movable keyboard, in which the keyboard can slide on a display screen of the handheld device, so that the keyboard will not occupy the critical display area on the handheld device.

Another aspect of the present invention is to provide a handheld device having a movable keyboard, in which the handheld device is set with a location capacitance sensor that can detect the displacement of the movable keyboard, so that the location of the movable keyboard on a display screen can be detected, and a selective item on the display screen corresponding to the location of the movable keyboard can be selected. In addition, by cooperating with the energy-conservation function of an e-ink display module, the refresh frequency of the display module can be greatly decreased, so that the power-consumption of the handheld device can be lowered to conserve energy and protect the environment.

According to the aforementioned aspects, the present invention provides a handheld device having a movable keyboard, comprising: a body, wherein a surface of the body includes a first region and a second region; a display module disposed in the body, and comprising a display screen exposed in the first region of the body; a handwriting input module disposed in the body, and comprising a handwriting screen located in the second region of the surface of the body; and a movable keyboard module slidably disposed over the surface of the body.

According to a preferred embodiment of the present invention, the body comprises at least one track disposed on a first side of the body, and the movable keyboard module comprises at least one sliding portion suitable to sliding along the track.

According to the aforementioned aspects, the present invention provides a handheld device having a movable keyboard, comprising: a body; a display module disposed in the body, and comprising a display screen exposed in a surface of the body; a movable keyboard module slidably disposed over the surface of the body; and a location capacitance sensor disposed between the body and the display module to sense the location of the movable keyboard module relative to the surface of the body.

According to a preferred embodiment of the present invention, the movable keyboard module is a QWERTY standard keyboard.

### BRIEF DESCRIPTION OF THE DRAWINGS

FIG. 1 illustrates a top view of a handheld device having a movable keyboard in accordance with a preferred embodiment of the present invention;

FIG. 2 illustrates a top view of a handheld device having a movable keyboard in accordance with a preferred embodiment of the present invention;

FIG. 3 is a three-dimensional diagram of a handheld device having a movable keyboard in accordance with a preferred embodiment of the present invention;

FIG. 4 illustrates an assembly diagram of a handheld device having a movable keyboard in accordance with a preferred embodiment of the present invention; and

FIG. 5 is a schematic diagram showing the operation of a handheld device having a movable keyboard in accordance with a preferred embodiment of the present invention.

### DETAILED DESCRIPTION OF THE PREFERRED EMBODIMENT

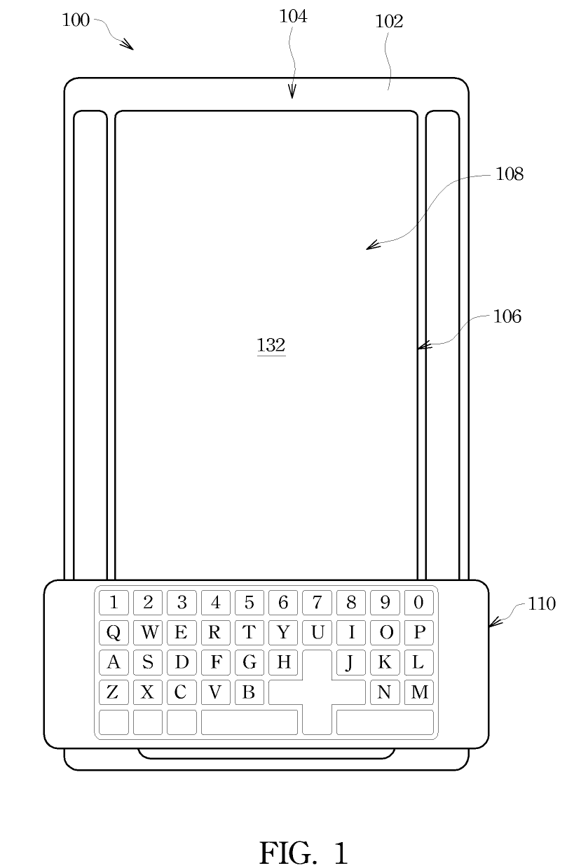

The present invention discloses a handheld device having a movable keyboard. In order to make the illustration of the present invention more explicit, the following description is stated with reference to FIG. 1 through FIG. 5.

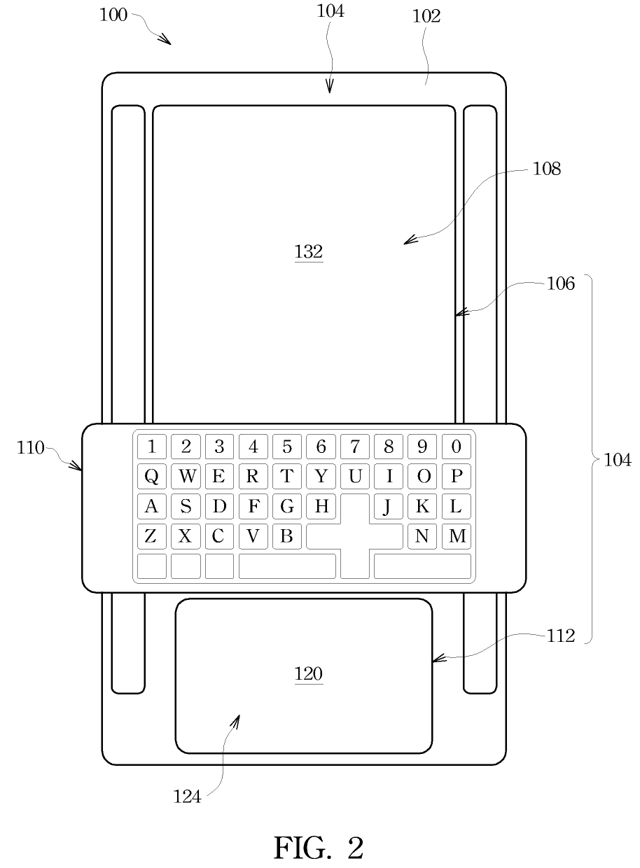

Refer to FIG. 1 and FIG. 2. FIG. 1 and FIG. 2 illustrate top views of a handheld device having a movable keyboard in two states in accordance with a preferred embodiment of the present invention. A handheld device 100 may be a common portable electronic device, such as a mobile phone, a personal digital assistant (PDA) and an electronic book. In an exemplary embodiment, the handheld device 100 is an electronic book, and the handheld device 100 mainly comprises a body 102, a display module 108, a handwriting input module 124 and a movable keyboard module 110. The display module 108 and the handwriting input module 124 are disposed in the body 102, and the movable keyboard module 110 is slidably disposed over a surface 104 of the body 102, wherein the surface 104 of the body 102 is located on the front side of the handheld device 100. Such as shown in FIG. 2, the surface 104 of the body may divided into at least two regions 106 and 112, wherein the upper region 106 may be used as a display region of the handheld device 100, and the lower region 112 may be used as a handwriting input region.

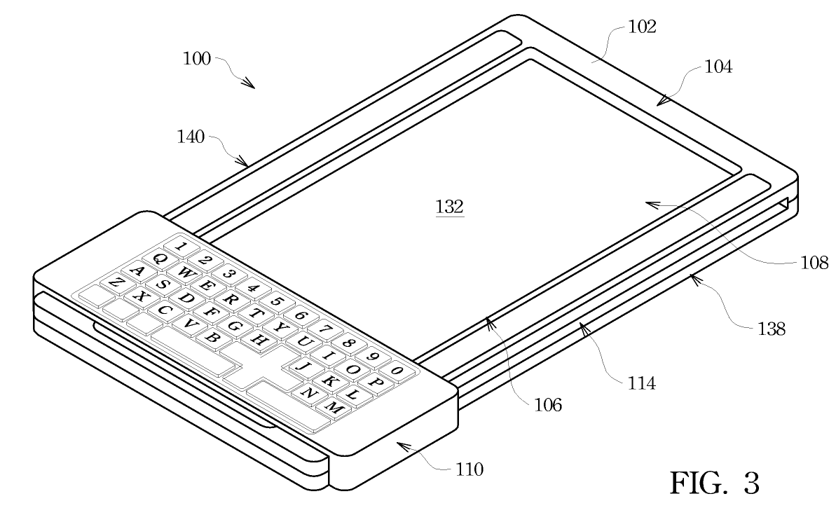

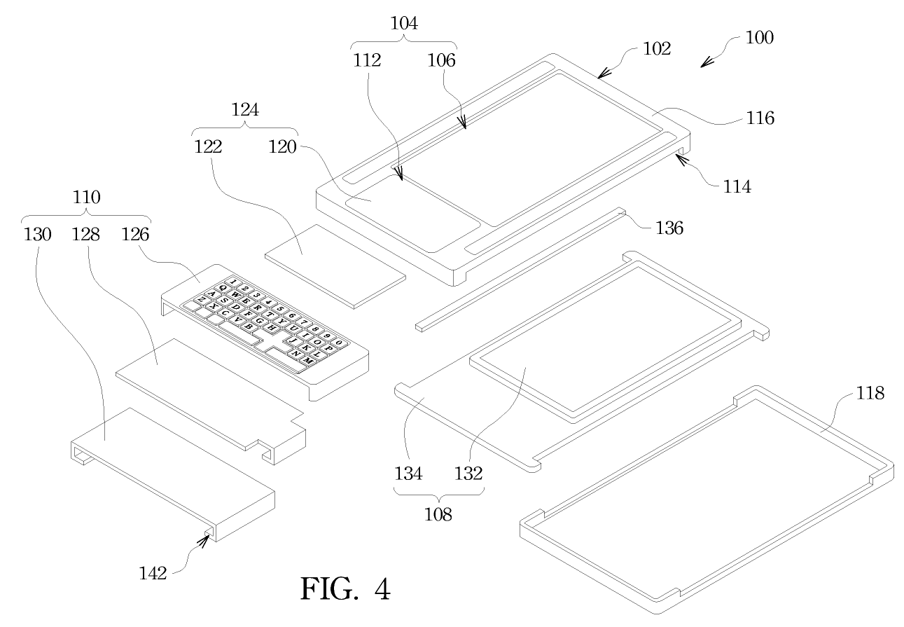

Refer to FIG. 3. FIG. 3 is a three-dimensional diagram of a handheld device having a movable keyboard in accordance with a preferred embodiment of the present invention. In an embodiment, at least one of two opposite sides 138 and 140 of the body 102 may be set with a track 114, and the movable keyboard module 110 correspondingly comprises at least one sliding portion 142 (referring to FIG. 4), wherein the sliding portion 142 of the movable keyboard module 110 is correspondingly disposed on the track 114 of the body 102, and the movable keyboard module 110 can slide above the surface 104 of the body 102 while the sliding portion 142 slides along the track 114. In another embodiment, the body comprises two tracks 114 respectively disposed on the two opposite sides 138 and 140, and the movable keyboard module 110 comprises two corresponding sliding portions 142, wherein the two sliding portions 142 of the movable keyboard module 110 are respectively disposed on the two tracks 114 of the body 102, so that the movable keyboard module 110 can slide more steadily above the surface 104 of the body 102 along the tracks 114.

Refer to FIG. 4. FIG. 4 illustrates an assembly diagram of a handheld device having a movable keyboard in accordance with a preferred embodiment of the present invention. Simultaneously refer to FIG. 1, FIG. 2 and FIG. 3. In an embodiment, the body 102 may comprise an upper case 116 and a lower case 118, wherein the upper case 116 and the lower case 118 can be combined with each other to form a hollow housing to contain the internal elements of the handheld device 100. After the upper case 116 and the lower case 118 are combined, the track 114 is located on the side of the combined structure of the upper case 116 and the lower case 118. The upper case 116 and the lower case 118 may be composed of a plastic material. The handwriting input module 124 mainly comprises a handwriting screen 120 and a sensor 122, wherein the sensor 122 is disposed under the handwriting screen 120 to receive the input data transferred from the handwriting screen 120. Such as shown in FIG. 2 and FIG. 4, the handwriting screen 120 of the handwriting input module 124 is located in the lower region 112 of the surface 104 of the body 102.

Such as shown in FIG. 4, the display module 108 is disposed between the upper case 116 and the lower case 118 of the body 102. In an exemplary embodiment, the sensor 122 of the handwriting input module 124 may be disposed between the upper case 116 of the body 102 and the display module 108. The display module 108 may mainly comprise a display screen 132 and a circuit board 134, wherein the display screen 132 of the display module 108 is exposed in the upper region 106 of the surface 104 of the body 102, such as shown in FIG. 1, FIG. 2, FIG. 3 and FIG. 4. In a preferred embodiment, the display module 108 may be manufactured by an e-ink technique to save the energy consumption of the handheld device 100.

Such as shown in FIG. 4, the movable keyboard module 110 may mainly comprise a keyboard body 126, a circuit board and a shell 130, wherein the circuit board 128 and the shell 130 both are disposed under the keyboard body 126, and the circuit board 128 is placed in between the keyboard body 126 and the shell 130. In one embodiment, the circuit board 128 is a flexible circuit board, for example. In the movable keyboard module 110, the sliding portions 142 corresponding to the track 114 of the body 102 may be disposed on the shell 130 of the movable keyboard module 110 to facilitate the combination of the movable keyboard module 110 and the body 102. In one embodiment, the movable keyboard module 110 may be a QWERTY standard keyboard.

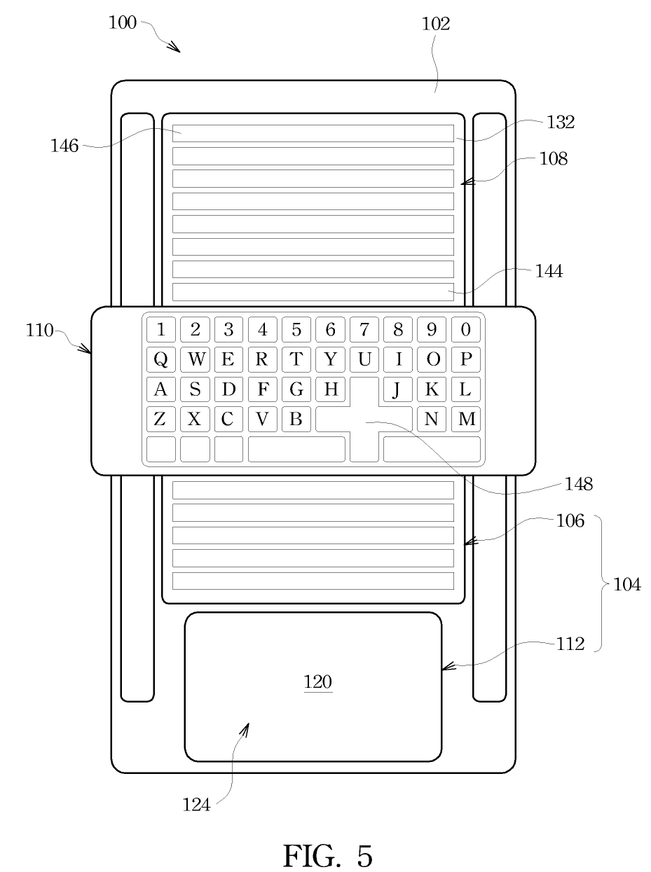

In a preferred embodiment, the handheld device 100 may selectively comprise a location capacitance sensor 136 according to the use requirement, wherein the location capacitance sensor 136 may be disposed between the upper case 116 of the body 102 and the display module 108 to facilitate detecting the movable keyboard module 110. The location capacitance sensor 136 can sense the displacement of the movable keyboard module 110 relative to the surface 104 of the body 102, and thereby can detect the location of the movable keyboard module 110 on the display screen 132. Refer to FIG. 5. When the display screen 132 of the display module 108 displays a plurality of selective items 146 for the user, the movable keyboard module 110 is moved on the display screen 132, and the upper edge of the movable keyboard module 110 is stopped closely next to the lower edge of the desired selective item 144, the location of the movable keyboard module 110 on the display screen 132 now can be sensed by the location capacitance sensor 136, and the user can select the corresponding selective item 144 on the display screen 132 by pushing down a predetermined button, such as an input button 148, of the movable keyboard module 110. In cooperating with the display module 108 formed by an e-ink technique, when the movable keyboard module 110 is slid to select the corresponding selective item 144 on the display screen 132, the display screen 132 of the display module 108 can be maintained in the same display frame without refreshing the display frame, so that the refresh frequency of the display module 108 can be greatly decreased to lower the power-consumption of the handheld device 100 to achieve the purpose of energy-conservation and environmental protection.

In another exemplary embodiment, the handheld device 100 having a movable keyboard may be selectively set with only one input device, i.e. the handheld device 100 is only set with the foregoing movable keyboard module 110 and is not set with the handwriting input module 124. As a result, the display screen 132 can be disposed on the overwhelming majority of the front space of the handheld device 100, i.e. the surface 104 of the body 102, to obtain larger display area.

According to the aforementioned embodiments of the present invention, one advantage of the present invention is that a keyboard of a handheld device having a movable keyboard can slide on a display screen of the handheld device, so that the convenience of the data inputting can be enhanced without occupying the rare display area on the handheld device.

According to the aforementioned embodiments of the present invention, another advantage of the present invention is that a handheld device having a movable keyboard is set with a location capacitance sensor, so that the displacement of the movable keyboard can be detected, the location of the movable keyboard on a display screen can be detected to select a selective item on the display screen corresponding to the location of the movable keyboard. In addition, by cooperating with the energy-conservation function of an e-ink display module, the refresh frequency of the display module can be greatly decreased, so that the power-consumption of the handheld device can be lowered to achieve the purpose of energy-conservation and environmental protection.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A handheld device having a movable keyboard, comprising:
a body, wherein a surface of the body includes a first region and a second region;
a display module disposed in the body, and comprising a display screen exposed in the first region of the body;
a handwriting input module disposed in the body, and comprising a handwriting screen located in the second region of the surface of the body; and
a movable keyboard module slidably disposed over the surface of the body.

2. The handheld device according to claim 1, wherein the body comprises at least one track on a first side of the body, and the movable keyboard module comprises at least one sliding portion suitable to sliding along the at least one track.

3. The handheld device according to claim 2, wherein the at least one track comprises two tracks respectively on the first side and a second side of the body opposite to the first side, and the at least one sliding portion comprises two sliding portions respectively disposed on the tracks.

4. The handheld device according to claim 2, wherein the movable keyboard module comprises:
a keyboard body;
a shell disposed under the keyboard body; and
a circuit board disposed in between the keyboard body and the shell.

5. The handheld device according to claim 4, wherein the circuit board comprises a flexible circuit board.

6. The handheld device according to claim 4, wherein the at least one sliding portion is disposed on the shell.

7. The handheld device according to claim 1, wherein the body comprises an upper case and a lower case.

8. The handheld device according to claim 7, wherein the handwriting input module further comprises a sensor disposed under the handwriting screen.

9. The handheld device according to claim 8, wherein the display module is disposed between the upper case and the lower case, and the sensor is disposed between the upper case and the display module.

10. The handheld device according to claim 7, further comprising a location capacitance sensor disposed between the upper case and the display module to sense a location of the movable keyboard module relative to the surface of the body.

11. The handheld device according to claim 1, wherein the display module comprises an e-ink display module.

12. The handheld device according to claim 1, wherein the handheld device comprises an electronic book.

13. The handheld device according to claim 1, wherein the movable keyboard module comprises a QWERTY standard keyboard.

14. A handheld device having a movable keyboard, comprising:
a body;
a display module disposed in the body, and comprising a display screen exposed in a surface of the body;
a movable keyboard module slidably disposed over the surface of the body; and
a location capacitance sensor disposed between the body and the display module to sense a location of the movable keyboard module relative to the surface of the body.

15. The handheld device according to claim 14, wherein the body comprises at least one track on a first side of the body, and the movable keyboard module comprises at least one sliding portion suitable to sliding along the at least one track.

16. The handheld device according to claim 15, wherein the at least one track comprises two tracks respectively on the first side and a second side of the body opposite to the first side, and the at least one sliding portion comprises two sliding portions respectively disposed on the tracks.

17. The handheld device according to claim 15, wherein the movable keyboard module comprises:
a keyboard body;
a shell disposed under the keyboard body; and
a circuit board disposed in between the keyboard body and the shell.

18. The handheld device according to claim 17, wherein the circuit board comprises a flexible circuit board.

19. The handheld device according to claim 17, wherein the at least one sliding portion is disposed on the shell.

20. The handheld device according to claim 14, wherein the body comprises an upper case and a lower case.

21. The handheld device according to claim 20, wherein the display module is disposed between the upper case and the lower case.

22. The handheld device according to claim 14, wherein the display module comprises an e-ink display module.

23. The handheld device according to claim 14, wherein the handheld device comprises an electronic book.

24. The handheld device according to claim 14, wherein the movable keyboard module comprises a QWERTY standard keyboard.
